(19) United States
(12) Patent Application Publication
(10) Pub. No.: US 2012/0262673 A1
(43) Pub. Date: Oct. 18, 2012

(54) VEHICULAR INFORMATION DISPLAY SYSTEM AND METHOD

(75) Inventor: Annika Larsson, Goeteborg (SE)

(73) Assignee: VOLVO CAR CORPORATION, Goteborg (SE)

(21) Appl. No.: 13/443,258

(22) Filed: Apr. 10, 2012

(30) Foreign Application Priority Data
Apr. 15, 2011 (EP) 11162531.5

(51) Int. Cl. G03B 21/14; B60J 1/08

(52) U.S. Cl. 353/13; 353/121; 296/146.15

(57) ABSTRACT

An exterior window of a vehicle has an array of opaque elements on at least a portion of its surface. The elements reflect light emitted by a video projector inside the vehicle to serve as a display screen for images visible to an occupant of the vehicle. The window is transparent in the spaces surrounding the opaque elements so that the exterior environment is simultaneously visible to the occupant. The displayed image is based on a geographical location of the vehicle and includes information about an actual geographic subject in the vicinity of the vehicle. The image may be projected on the display pattern in a location such that the image and the actual geographic subject are viewable simultaneously through the window.

### CROSS-REFERENCE TO RELATED APPLICATIONS

This application claims foreign priority benefits under 35 U.S.C. §119(a)-(d) to EP 11162531.5, filed Apr. 15, 2011, the disclosure of which is incorporated in its entirety by reference herein.

### TECHNICAL FIELD

The present invention relates to presenting and displaying information, such as images, text, or video, to occupants of a vehicle and in particular to an information display system using an exterior window of a vehicle for presenting and displaying information to the occupants.

### BACKGROUND

Today, there exist various examples of systems for presenting and displaying information to the driver and other occupants of a vehicle.

These systems generally include a display screen arranged on the dashboard or the instrument panel, in front of the driver. Display arrangements have been proposed which display information on a predetermined section on or adjacent to the windshield in front of the driver. However, these known arrangements are restricted to presenting and displaying vehicle information to the driver either adjacent the front windshield or on a display screen in front of the driver. This vehicle information is normally restricted to information such as speed fuel, time, and other indicators for vehicle driving.

Further, there exist various examples of vehicle navigation display systems which provide the driver and/or the passengers with navigational information on a display screen in front of either the driver or the passenger. However, these known systems are restricted to presenting and displaying navigational information for the vehicle on a display screen making it difficult to compare the navigational information on the display screen to the outside surroundings around the vehicle. Further, these known vehicle navigation display systems are mainly restricted in providing navigational information for the vehicle to the driver of the vehicle. There is no or relatively little navigational information for the vehicle to the passengers of the vehicle.

### SUMMARY

In an embodiment disclosed herein, an information display system for a vehicle comprises a video projector installed in the vehicle and an exterior window having a display pattern on a surface thereof. The display pattern comprises an array of opaque elements on at least a portion of the surface, the elements reflecting light emitted by the projector to display an image visible to an occupant of the vehicle.

In another embodiment disclosed herein, an exterior window for a vehicle comprises a transparent pane and an array of opaque elements on at least a portion of a surface of the pane. The array forms a display pattern to reflect light directed onto it from inside the vehicle.

In another embodiment disclosed herein, a method of displaying information to an occupant of a vehicle comprises providing a window having a display pattern comprising an array of substantially opaque elements covering at least a portion of the surface, and projecting light onto the window to form an image on the display pattern visible to the occupant.

According to a further embodiment, the image is based on a geographical location of the vehicle and includes information about an actual geographic subject in the vicinity of the vehicle. The image may be projected on the display pattern in a location such that the image and the actual geographic subject are viewable simultaneously through the window.

### BRIEF DESCRIPTION OF THE DRAWINGS

Embodiments of the present invention described herein are recited with particularity in the appended claims. However, other features will become more apparent, and the embodiments may be best understood by referring to the following detailed description in conjunction with the accompanying drawings, in which:

FIG. 1 schematically shows a pictorial representation of vehicle comprising a window according to the invention.

FIG. 2 schematically shows a pictorial representation of a projection of a geographical subject according to the invention.

FIG. 3 schematically shows a pictorial representation of the display pattern according to the invention.

FIG. 4 schematically shows a pictorial representation of a first transition display pattern according to the invention.

FIG. 5 schematically shows a pictorial representation of a second transition display pattern according to the invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

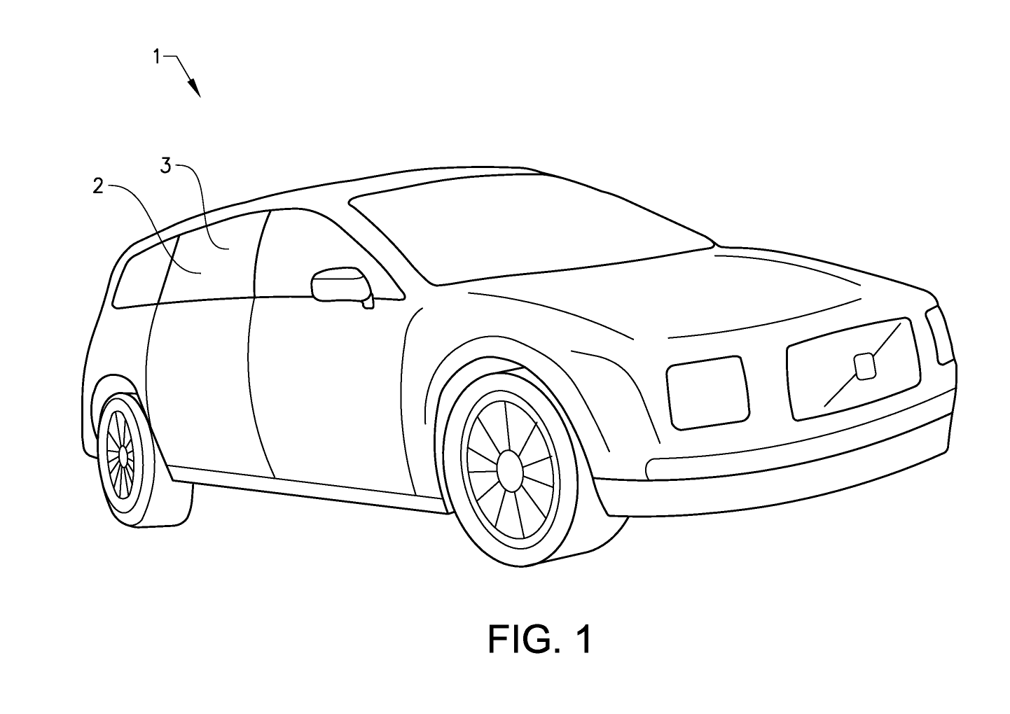

FIG. 1 shows an example of a vehicle 1 having an information display system according to the invention. The vehicle 1 comprises an exterior window 2 having an outside surface 3. The depiction in FIG. 1 of the rear side window 2 is for descriptive purposes only, as any window at any location on the vehicle 1 may be provided with the disclosed information display system.

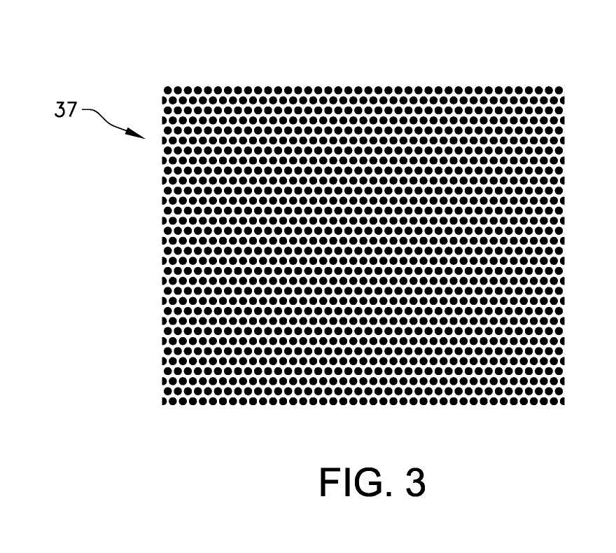

The inside of window 2 is provided with a display pattern comprising an array of opaque elements, such as the pattern shown in FIG. 3, which functions as a display screen.

The opaque elements of the display pattern may be applied to the window 2 by a printing process and/or by a laminating process. The opaque elements may be made of any suitable material. One or more video projectors (not shown) are provided inside the vehicle 1. These one or more projectors project information images onto the display pattern on the window.

The display pattern may be constituted of a so-called print screen overlaying all or a portion of the surface of the window 2. The opaque pattern may for instance be a print screen having openings wherein the surface between the openings is opaque and constitute the display pattern onto which information images can be projected and displayed to the occupant, while the openings allow the occupant to see the surroundings around the vehicle. The openings may be of any type of suitable geometrical form, such as circular, square or triangular. The openings may be all of substantially the same size or of different sizes.

In another embodiment, the window 2 may be provided with a laminate, on which it is possible to project an information image so that the laminate adopts the information image. The laminate may be arranged on the inner or outer surface of the vehicle window 2, or between the layers of a multi-ply window.

The display pattern may cover only a part of the window, so that the display pattern is located in any suitable location on window, for example in the center, along one or more edges, or in one or more the corners of the window.

The opaque pattern may be partly covering the window in a substantially symmetrical manner. No additional parts or space is required in order to provide the passengers with information about the outside surroundings.

The display pattern may be arranged on a windshield, a front side, a rear side and/or a rear window, or any portions thereof. There is sufficient transparent space between/around the opaque elements that the display pattern is see-through when viewed from the inside, but works as an optical filter when viewed from the outside.

FIG. 3 shows a window pane 37 with an example of a display pattern arranged on it. The display pattern comprises an array of multiple opaque elements or pixels of substantially the same size and arranged in a substantially uniform, grid-like pattern, wherein the distances between adjacent elements are generally uniform. However, the size of the opaque elements may be varied and/or the distances between the opaque elements may vary over the surface of the window. The image projected onto the display pattern will not be visible on the surfaces/spaces between the opaque elements. The relationship between the surface of the display pattern and the surface of the window pane is adaptable.

The opaque elements may be of a silver, grey, or dark color when viewed from the outside of the vehicle, and of a light or white color when viewed from the inside of the vehicle. However, the color of the opaque elements may be varied. The color of the opaque elements can also be the same looking from both the inside and the outside of the vehicle.

A ratio between the total surface area of the display pattern and the total window surface area is at least 10%, preferably in the range of 30% to 80%, more preferably in the range of 40% to 70%, and most preferably in the range of 50% to 60%. The display pattern surface is either the display surface of the print screen between the openings or the display surface of the opaque elements.

The information display system provides a partly transparent window looking from the inside of the vehicle and the appearance of a relatively non-transparent window as viewed by a person outside of the vehicle. Since it normally is darker inside the vehicle than outside the vehicle, it appears from the outside of the vehicle that the window is provided with a relatively non-transparent sun- or light-protecting film.

Thus, due to normal lighting relation between the passenger compartment of the vehicle and the outside surroundings, a relatively low transparency can be provided when looking from the outside of the vehicle through the window into the vehicle.

Conversely, the disclosed information display system can also provide a relatively high transparency from the inside of the vehicle through the window out from the vehicle and simultaneously enable the projection and displaying of information about the outside surroundings onto the display pattern.

The video projector(s) can display information images including, for example, those from television, film or the internet. The projector(s) can also present and display information in the form of information images related to the outside surroundings. The video projector(s) can be operatively connected to a navigation system, such that the information image can be based on the geographical location of the vehicle 1. For example, if the vehicle 1 passes an actual geographical subject of interest (such as a man-made or a natural feature or a historic site), information relating to this actual geographical subject can be presented on the display pattern to the occupants. This type of information may include any type of additional information such as opening hours, prices, shows or phone numbers related to the actual geographical subject.

Thus, the vehicle occupant(s) can simultaneously see the actual surroundings with the actual geographical subjects and the projected information images of the actual geographical subjects together with additional information relating to the actual geographical subjects. The disclosed display system can function as an information guide or a travel guide providing the occupant(s) with additional information about the outside surroundings around the vehicle. The occupants do not need to look away from the rear side window to receive the additional information.

To enable the displayed to be based on the geographical location of the vehicle, the information image may be obtained/selected in coordination with a navigation system. The navigational system is arranged to be in communication with the one or more video projectors such that information can be transferred from the navigational system via the one or more video projectors and onto the display pattern on window. The navigation system can be a satellite-based system, such as GPS, and/or an inertial navigation system. The information image may be projected so as to be movable along the display pattern on the window in relation to the movement of the vehicle.

The vehicle occupants may be able to select which type of geographic subject is to be projected and displayed on the display pattern. This can for example be done by using an input device in the information display system or by using an existing user interface.

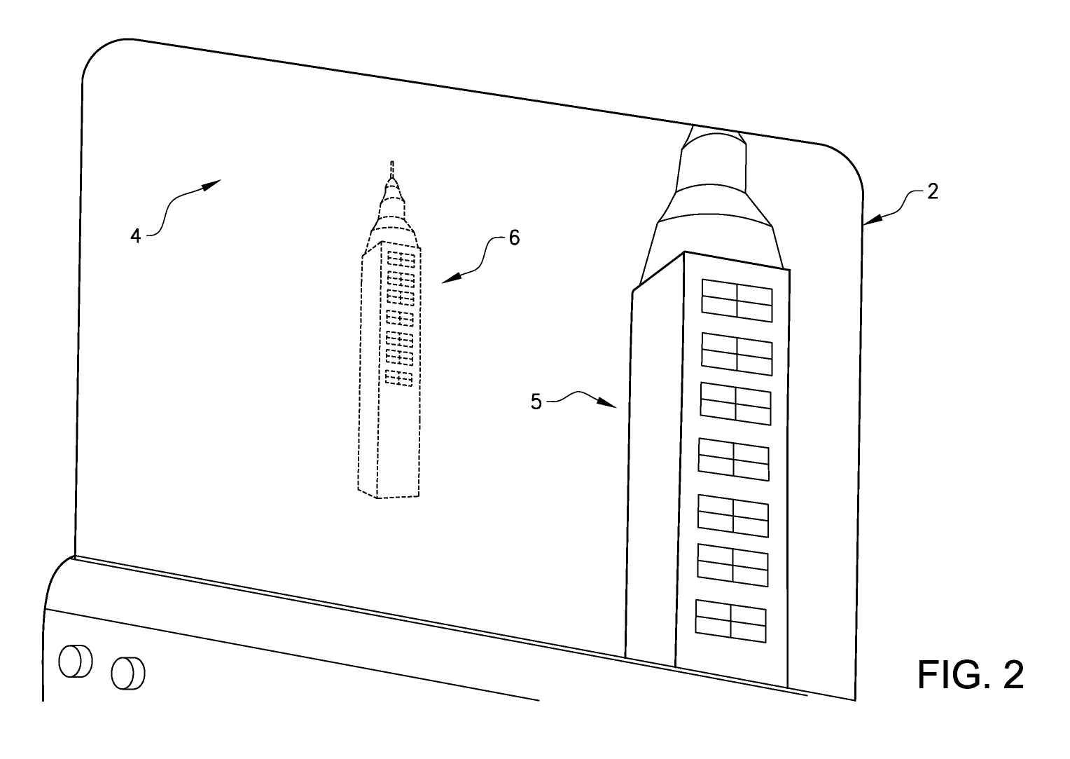

FIG. 2 shows an information image 6 projected on an inside surface 4 of a window 2. In the example depicted, the information image 6 corresponds to an actual geographical subject 5, a building, which can be seen through the window 2. The information image 6 may, as shown, be a depiction of the actual geographical subject 5. Or the image may take the form of only text information, or a depiction along with text information or figures, and/or of any desired additional information relating to the actual geographical subject 5.

The information image projected onto the display pattern is, when viewed by the vehicle occupant, superimposed over a background that is the view of the actual surroundings outside of the window, this background being visible to the occupant through the display pattern. The one or more video projectors can be arranged inside the vehicle such that they can be directed towards any suitable vehicle window or part thereof inside the vehicle. For example, the one or more video projectors can be located on the inside of the roof of the vehicle, and/or on a seat or seats inside the vehicle.

When viewed by a person located outside of the vehicle 1, the display pattern may cause the window 2 to appear that it is provided with a sun- or light-protecting film. On the inside of the vehicle 1, in the vehicle compartment, it is possible to see the surroundings around the vehicle 1 between/around the opaque elements of the display pattern. This enables the occupants to easily compare and connect the information image 6 with the actual geographical subject 5. Further, this enables the occupants to easily compare and connect the information image 6 having additional information with the actual geographical subject 5.

The size of the opaque elements can vary over the surface of the window. For example the elements may decrease or increase in size towards one or all the edges of the window. Such a pattern can give a transition section of the window between the display pattern and a window frame. The opaque elements may be of the same size across most of surface of the window, but increase or decrease in size in the transition sections adjacent the window edges to provide for a smooth transition between the window and the window frame.

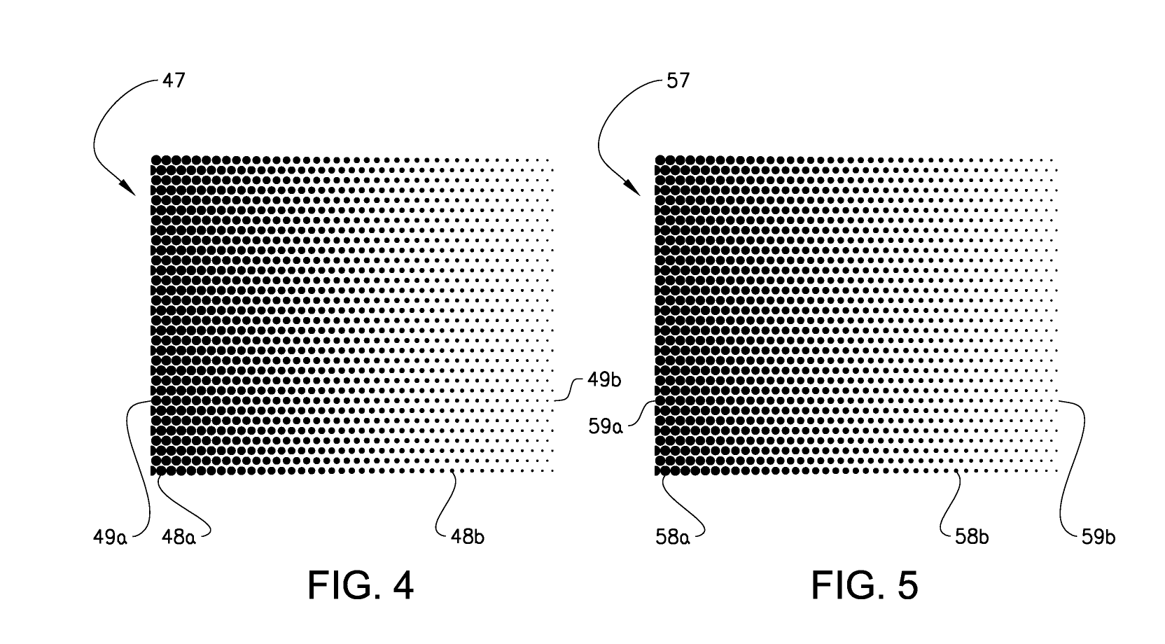

FIG. 4 shows an example of a display pattern comprising a transition display pattern at or approaching the edges of the display pattern, i.e. at the edges of the window pane 47 adjacent to the window frame. A first opaque element or dot 48a at a first edge or side 49a of the pattern is larger than a second opaque element or dot 48b at a second edge or side 49b of the array. The first side 49a may be closer to the center of the window while the second side 49b coincides with a peripheral edge of the window. The opaque elements thus gradually decrease in size in a uniform manner from the center of the window towards one or more of the peripheral edges of the window.

FIG. 5 shows an example of a second transition display pattern arranged on a window pane 57 adjacent the window frame according to the invention. Referring to FIG. 5, a third opaque element or dot 58a at a third side 59a of the second transition display pattern is larger than a fourth opaque element or dot 58b at a fourth side 59b of the second transition display pattern, i.e. the size of the opaque elements gradually increase towards the edges of the second window. The fourth side 59b is closer to the center of the first rear side window than the third side 59a. The third side 59a of the second transition display pattern coincides with the edge of the second rear side window.

The information display system according to the invention may be used in any type appropriate vehicle in the form of, for example, a car, a truck, a bus, or other vehicle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An information display system for a vehicle comprising:
a video projector installed in the vehicle; and
an exterior window having a display pattern on a surface thereof, the display pattern comprising an array of opaque elements on at least a portion of the surface, the elements reflecting light emitted by the projector to display an image visible to an occupant of the vehicle.

2. The system according to claim 1 wherein the display pattern covers at least a portion of the window surface in a symmetrical manner.

3. The system according to claim 1 wherein that the display pattern is a print screen, with or without openings.

4. The system according to claim 1 wherein the opaque elements are circular.

5. The system according to claim 1 wherein that the opaque elements vary in size in a uniform manner over the surface.

6. The system according to claim 1 wherein that the display pattern is arranged on a rear side window of the vehicle.

7. The system according to claim 1 wherein a ratio between a display pattern surface and a window surface is in a range of 50 to 60 percent.

8. An exterior window for a vehicle comprising:
a transparent pane; and
an array of opaque elements on at least a portion of a surface of the pane, the array forming a display pattern to reflect light directed onto it from inside the vehicle.

9. The window according to claim 8 wherein the array covers at least a portion of the window surface in a symmetrical manner.

10. The window according to claim 8 wherein that the array is a print screen, with or without openings.

11. The window according to claim 8 wherein the opaque elements are circular.

12. The window according to claim 8 wherein that the opaque elements vary in size in a uniform manner over the surface.

13. The window according to claim 8 wherein a ratio between a display pattern surface and a window surface is in a range of 50 to 60 percent.

14. A method of displaying information to an occupant of a vehicle comprising:
providing a window having a display pattern on a surface thereof, the display pattern comprising an array of substantially opaque elements covering at least a portion of the surface; and
projecting light onto the window to form an image on the display pattern visible to the occupant.

15. The method according to claim 14 wherein that the image is based on a geographical location of the vehicle.

16. The method according to claim 15, wherein that the image is obtained by a navigation system.

17. The method according to claim 14 wherein the image corresponds to a geographic subject viewable through the display pattern.

18. The method according to claim 17 further comprising the occupant selecting the geographic subject and corresponding image displayed on the display pattern.

19. The method according to claim 14 wherein that the image is movable over the display pattern in coordination with movement of the vehicle.
